(19) United States
(12) Patent Application Publication
(10) Pub. No.: US 2014/0253871 A1
(43) Pub. Date: Sep. 11, 2014

(54) CONTACT LENSES

(71) Applicants: Ian Neil Douglas Rosser, Queensland (AU); Donald Ian Gillespie, Queensland (AU)

(72) Inventors: Ian Neil Douglas Rosser, Queensland (AU); Donald Ian Gillespie, Queensland (AU)

(21) Appl. No.: 14/235,189

(22) PCT Filed: Jun. 28, 2012
(86) PCT No.: PCT/AU2012/000748

§ 371 Date: May 5, 2014

(30) Foreign Application Priority Data
Jul. 26, 2011 (AU) 2011902990

(51) Int. Cl. G02C 7/04

(52) U.S. Cl. CPC G02C 7/04
USPC 351/159.24; 351/159.73

(57) ABSTRACT

A contact lens for application to the cornea of an eye comprising (a) a peripheral area having dot colour matrix; and (b) a central area having a base tint.

### FIELD OF THE INVENTION

The invention relates to a contact lens and in particular lenses useful in enhancing colour vision perception in people suffering from visual disabilities such as colour vision deficiency (“CVD”), dyslexia or photophobia. The invention also relates to a process for producing the contact lens.

### BACKGROUND OF THE INVENTION

In this specification, where a document, act or item of knowledge is referred to or discussed, this reference or discussion is not an admission that the document, act or item of knowledge or any combination thereof was at the priority date, publicly available, known to the public, part of common general knowledge; or known to be relevant to an attempt to solve any problem with which this specification is concerned. Whilst the following discussion is in terms of a contact lens to enhance colour vision perception in people suffering from colour vision deficiency (“CVD”), dyslexia or photophobia, a person skilled in the art will appreciate that the invention is not so limited and may be used in people affected by a number of different conditions and other visual disabilities.

CVD which is most commonly, but incorrectly, referred to as colour blindness affects approximately 8% of males and 0.5% of females. It is a hereditary condition and people affected by CVD often consider the condition to be a disability. The most common type of CVD is the red-green deficiencies that are categorized from mild to medium or strong. It is less common for people to be affected with blue and yellow confusion.

For several years now, spectacle and contact lenses have been made with specific tints that improve the colour perception for those with red-green CVD. These spectacles and contact lenses are effective for the majority of people with CVD and will allow most to pass the Ishihara test, which is a well known screening test for CVD.

There have been numerous patents lodged since 1972, for contact lenses for enhancing colour vision. However, the majority of these patents have remained as unfulfilled ideas and have not resulted in the commercialisation of a useful product.

Contact lenses by their very nature are applied to the eye's outer surface, the cornea, and strict guide lines are in place as to what tints can be applied to a lens in order to still allow sufficient oxygen transmission to maintain the health and integrity of the cornea. Over the years, through a process of trial and error, a number of tints have been developed and are now applied to spectacles and lenses. The wider selection of tints means that the most appropriate tints can now be used to give maximum improvement in colour vision perception to people affected by CVD.

However, despite the improvement in colour vision perception, the spectacles or contact lenses treated with an appropriate tint may not be used by people affected by CVD. This is because the contact lenses have a reddish coloured tint which may not be cosmetically appealing. The tinted contact lenses lead to a change in the appearance of the natural colour of the eye. The overall change depends on the natural background colour and is more obvious in people who have lighter coloured eyes. However, even against a dark brown eye it is obvious that the wearer has a contact lens in his or her eye. Moreover, a tinted contact lens which is worn by people who have lighter coloured irises result in an unwelcome ‘alien’ appearance to the eyes of the wearer.

There are a number of methods for tinting, and types of tinted, contact lenses for use by people with CVD but none of these available contact lenses are thought to be cosmetically acceptable. If the whole lens is tinted, it results in a very unnatural reddish appearance to the iris and if the contact lens is only placed in one eye this accentuates the difference in colour between the irises.

It is also possible to only tint a small central portion of the lens instead of the whole lens. However, this method also does not result in a cosmetically acceptable product. When only a small central portion of the contact lens is tinted, as in U.S. Pat. Nos. 4,998,817 and 6,089,712 and JP2000047146A, the pupil of the wearer appears to be significantly dilated and may also appear decentered if the contact lens is not sitting exactly in line with the visual axis. Moreover, this method also results in a contact lens which is less effective in enhancing colour perception as the method of only tinting a small central region of the contact lens still allows a large amount of ambient light through and around the untinted portions of the contact lens which greatly lessens the effect for the wearer.

ChromaGen lenses were originally only worn in one eye to try and balance the visual effect for the user and more recently, ChromaGen have lodged a patent application (WO 2009/011703) for applying a neutral density filter to the front surface of the contact lens to try and disguise the back surface colour. This may have an overall darkening effect to the appearance of the iris colour and consequently still draw unwanted attention by an observer. Moreover, any additional tint applied to the contact lens over the CVD tint will reduce the total light transmitted through to the light receptors in the retina of the eye. This would reduce the effect of the CVD tint and make the contact lens less effective. If there is less visible light transmitted, the wearer of the contact lens may also not be able to function effectively in low level lights.

There are a number of people who are affected by CVD who would benefit from wearing contact lenses which enhance colour perception. However, a number of people are reluctant to wear the commercially available contact lenses due to the unusual aspect to the colour of the eye which result from wearing the contact lenses. There is also concern that wearing of the contact lenses would result in even more stigmatization from other people.

### SUMMARY OF THE INVENTION

The contact lenses according to the invention addresses the unacceptable cosmetic appearance of the commercially available contact lenses for use by people affected by visual disabilities such as people affected with CVD by using a combination of a dot colour matrix and tinted areas which give enhanced colour vision perception.

A dot colour matrix is a number of small coloured dots (usually non visually differentiable) applied to a contact lens particularly in the peripheral area. There are no dots in a central zone to allow unrestricted visual acuity. The dots may be of the same or differing colour depending upon what overall colour appearance is desired.

Accordingly there is provided a contact lens for application to the cornea of an eye comprising:
(a) a peripheral area having a dot colour matrix; and
(b) a central area having a base tint.

Typically, the lens has at least a portion of the peripheral area further including a base tint. Preferably, the base tint in the peripheral and central areas is the same.

Typically, the lens has a front surface and back surface and the base tint is located upon one of those surfaces. Alternatively, the base tint is incorporated integrally into the lens.

Typically, the dot colour matrix is located on the front surface of the lens.

Typically, the central area is substantially disc shaped. Preferably the substantially disc shaped area has a diameter of about 5 mm.

The base tint may be located across the entire substantially disc shaped area and at least 2 mm of the adjacent peripheral area.

Whilst it will be understood that the invention is not so limited, the base tint may be selected from the range of commercially available tints, including tints which have spectrophotometer characteristics which are substantially similar to the spectrophotometer characteristics of the following Lee filters, or combination of Lee filters:
(a) 111 Dark Pink, 247 Lee Minus Green;
(b) 107 Light Rose and 152 Pale Gold;
(c) 107 Light Rose, 157 Pink;
(d) HT013 Straw Tint, 002Rrose Pink;
(e) 111 Dark Pink, 790 Moroccan Pink; and
(f) Rosy Amber 193 and Bright Rose 148.

The above are example of filters which result in the most effective CVD treatment effect. The examples are selected from the Lee Filter range. The coded numbers relate to the colours and page numbers of the Lee filter swatches.

In another embodiment of the invention, a process is provided for producing a contact lens comprising the steps of:
(a) dehydrating the contact lens;
(b) applying to the front surface and/or back surface of the lens a plurality of non visually differentiable dots of predetermined colour(s) to form the dot colour matrix;
(c) rehydrating the contact lens, and
(d) applying the base tint to the lens.

As will be apparent, the use of a dot colour matrix to place small coloured dots over a contact lens disguises the reddish appearance of the base tint in the peripheral area and the central region of the contact lens is over the pupil area which may typically be black and so the base colour blends into this black background. Thus the contact lens appears like any dot matrix lens and will change the eye's colour but will have a natural appearance to any observer.

Another advantage of the contact lenses according to this embodiment of the invention is that, unlike the ChrornaGen lens described above, there is a greater amount of visible light transmitted to the retina of the eye as there is no extra tint applied and the light only has to pass through the CVD tint. Therefore, the contact lenses according to this embodiment will give the wearer the best possible effect of the CVD tint with the least amount of visible light reduction giving a greater functionality over any other commercially available contact lenses such as the ChromaGen lens.

This combination of dot matrix and central tinting could also be used for any type of tinting application e.g. dyslexia tints, which would allow the wearer to have a natural appearance to their eyes yet have the effective benefit from the appropriate tinting.

### EXAMPLE

Various embodiments/aspects of the invention will now be described with reference to the following non-limiting example.

Gelflex made Ningaloo brand lenses were selected as they were already available in both plano or prescription contact lenses. This is a water hydrogel lens with 55% water and 43% Methafilcon A, with a base curve of 8.60 and diameter of 14.3 mm. The lenses were printed with any combination of dot matrix patterns while dehydrated, then rehydrated and inverted to have the colour vision enhancing tint applied from the back surface, in any diameter ranging from the complete lens surface down to a 3 millimeter central zone. However, it was found that the 7 mm zone gave the best visual appeal while still giving the optimum effect for the colour vision enhancement.

### BRIEF DESCRIPTION OF DRAWINGS

Various embodiments/aspects of the invention will now be further illustrated with reference to the non limiting accompanying drawings. It will be understood that the invention is not restricted to the embodiments shown which are provided by way of example only:

FIG. 1 is a drawing of a contact lens according to an embodiment the invention.

FIG. 2 is a drawing of a contact lens according to another embodiment of the invention.

### DETAILED DESCRIPTION OF THE DRAWINGS

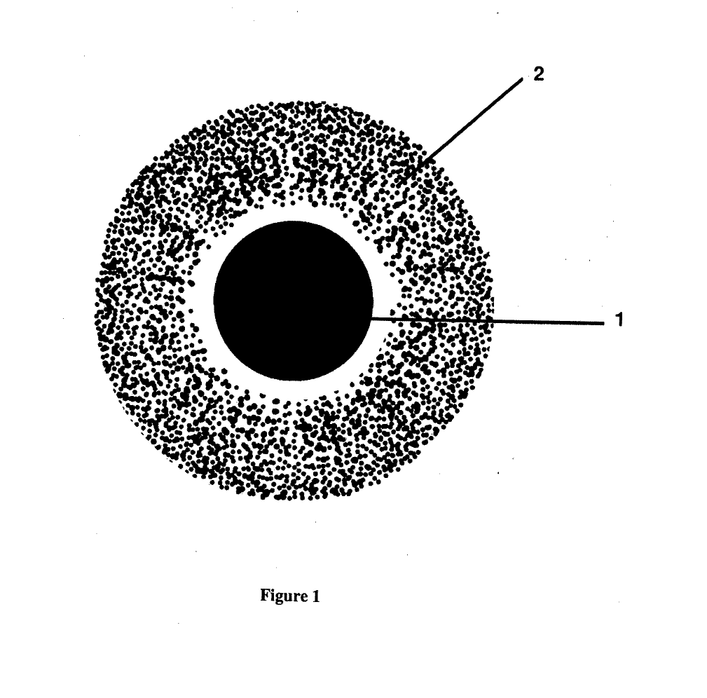

One form of the invention is shown in Figure. In FIG. 1, central area 1 is surrounded by a peripheral zone 2 having a dot colour matrix. Central area 1 is disk shaped and has a base tint applied to it. Central area 1 covers the pupil of the eye. Peripheral area 2 has a dot colour matrix consisting of small dots which are non-visually differentiable.

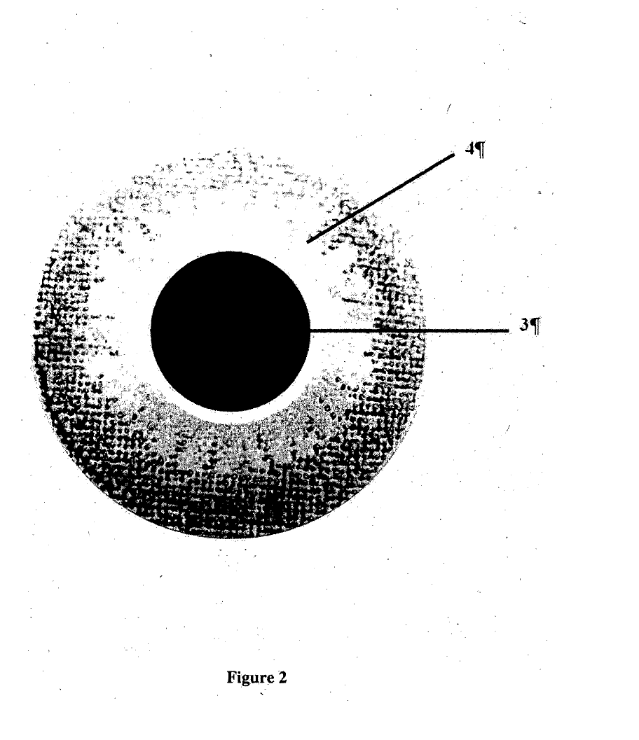

In FIG. 2, central area 3 is surrounded by a peripheral area 4 having a dot colour matrix. Central area 3 is disk shaped and has a base tint applied to it. Central area 3 covers the pupil of the eye. Peripheral area 4 has a dot colour matrix consisting of small dots which are non-visually differentiable and a base tint applied to the peripheral zone.

The word ‘comprising’ and forms of the word ‘comprising’ as used in this description and in the claims does not limit the invention claimed to exclude any variants or additions.

Modifications and improvements to the invention will be readily apparent to those skilled in the art. Such modifications and improvements are intended to be within the scope of this invention.

1. A contact lens for application to the cornea of an eye comprising:
(a) a peripheral area having a dot colour matrix; and
(b) a central area having a base tint,
wherein the base tint extends into at least avortion of the peripheral area adjacent the central area, and wherein the base tint has spectrophotometer characteristics that enhance colour vision perception in people suffering from visual disabilities including colour vision deficiency.

2. (canceled)

3. The lens of claim 4 wherein the base tint is located on the back surface of the lens.

4. The lens of claim 1 wherein the lens has a front surface and back surface and the base tint is located upon one of those surfaces.

5. The lens of claim 4 wherein the dot colour matrix is located on the front surface of the lens.

6. The lens of claim 1 wherein the base tint is incorporated integrally into the lens.

7. The lens of claim 1 wherein the central area is substantially disc shaped,

8. The lens of claim 7 wherein the substantially disc shaped area has a diameter of about 5 mm.

9. The lens of claim 7 wherein the base tint is located across the entire substantially disc shaped area and at least 2 mm of the adjacent peripheral area.

10. The lens of claim 1 wherein the base tint is selected from the range of commercially available tints, preferably tints which have spectrophotometer characteristics which are substantially similar to the spectrophotometer characteristics of the following Lee filters, or combination of Lee filters:
(a) 111 Dark Pink, 247 Lee Minus Green;
(b) 107 Light Rose and 152 Pale Gold;
(c) 107 Light Rose, 157 Pink;
(d) HT013 Straw Tint, 002Rrose Pink;
(e) 111 Dark Pink, 790 Moroccan Pink; and
(f) Rosy Amber 193 and Bright Rose 148.

11. The lens of claim 1 where in the dot colour matrix comprises a plurality of non visually differentiable dots of predetermined colour(s).

12. The lens of claim 1 when used to treat CVD, photophobia and/or dyslexia.

13. A process for producing a contact lens according to claim 4 having a front surface and back surface, comprising the steps of:
(a) dehydrating the contact lens;
(b) applying to the front and/or back surface a plurality of non visually differentiated dots of predetermined colour(s) to form the dot colour matrix;
(c) rehydrating the contact lens; and
(d) applying the base tint to the lens.
